(19) United States
(12) Patent Application Publication
(10) Pub. No.: US 2012/0147893 A1
(43) Pub. Date: Jun. 14, 2012

(54) E-Tree Interoperability Between MPLS Domain Devices and Ethernet Domain Devices

(75) Inventors: LIOR SHABTAY, RAMAT GAN (IL); ZHIPING JIA, BEIJING (CN)

(73) Assignee: NOKIA SIEMENS NETWORKS ETHERNET SOLUTIONS LTD.

(21) Appl. No.: 12/962,944

(22) Filed: Dec. 8, 2010

(51) Int. Cl. H04L 12/28

(52) U.S. Cl. 370/395.53

(57) ABSTRACT

An E-Tree service interoperability mechanism between VPLS domain devices (e.g., MPLS domain devices) and Ethernet domain devices. E-Tree interoperability functionality is provided whereby the E-domain device directly connected to the VPLS device is modified to perform an asymmetric VLAN tag manipulation on traffic forwarded between the VPLS device and itself. The capabilities of VPLS are used to divide between roots and leaves, even if both exist in the same E-domain, so that they do not share VLANs resulting in preventing roots and leaves in the same E-domain from communicating directly, but rather through the VPLS devices to which the E-domain connects. Traffic on the E-domain is segregated into a root VLAN to which roots are connected, a root-to-leaf VLAN for forwarding root-originated traffic from the VPLS-domain to the leafs, and a leaf-to-root VLAN for handling traffic originated by the leafs destined to roots.

### TECHNICAL FIELD

The disclosure relates generally to data communication systems and more particularly relates to a system and method for E-Tree interoperability between VPLS domain devices (e.g., MPLS domain devices) and Ethernet domain devices.

### BACKGROUND

The growth in demand for telecommunication services is increasing at an ever-quickening pace. The majority of the demand is being driven by the explosion in the use of the Internet and a steady stream of new applications being introduced which further increase the demand for increased bandwidth. With time, a smaller an smaller portion of Internet traffic is carried by circuit switched transport facilities. In the case of Metropolitan Area Networks (MANs), a significant part of the traffic is transported over SONET/SDH based networks most of which were originally resigned for voice traffic. With time, more and more customers are using the networks for transporting data rather than voice.

The requirements for networked communications within the user community have changed dramatically over the past two decades. Several notable trends in the user community include (1) the overwhelming domination of Ethernet as the core networking media around the world; (2) the steady shift towards data-oriented communications and applications; and (3) the rapid growth of mixed-media applications. Such applications include everything from integrated voice/data/video communications to the now commonplace exchanges of MP3 music files and also existing voice communications which have migrated heavily towards IP/packet-oriented transport.

Ethernet has become the de facto standard for data-oriented networking within the user community. This is true not only within the corporate market, but many other market segments as well. In the corporate market, Ethernet has long dominated at all levels, especially with the advent of high-performance Ethernet switching. This includes workgroup, departmental, server and backbone/campus networks. Even though many of the Internet Service Providers (ISPs) in the market today still base their WAN-side communications on legacy circuit oriented connections (i.e. supporting Frame Relay, xDSL, ATM, SONET) in addition to Ethernet in a significant part of the newer installations, their back-office communications are almost exclusively Ethernet. In the residential market, most individual users are deploying 10 or 100 Mbps Ethernet within their homes to connect PCs to printers and to other PCs (in fact, most PCs today ship with internal Ethernet cards) even though the residential community still utilizes a wide range of circuit-oriented network access technologies.

The use of Ethernet, both optical and electrical based, is increasing in carrier networks due to advantages of Ethernet and particularly Optical Ethernet, namely its ability to scale from low speeds to very high rates and its commodity-oriented nature. With the rapid increase in the demand for user bandwidth, and the equally impressive increase in the performance of Ethernet with the LAN environment, the demand for Metropolitan network performance is rapidly increasing. In response, there has been a massive explosion in the amount of fiber being installed into both new and existing facilities. This is true for both the corporate and residential markets.

Virtual private LAN service (VPLS) is a way to provide Ethernet based multipoint to multipoint communication over Internet Protocol (IP)/Multiprotocol Label Switching (MPLS) networks. It allows geographically dispersed sites to share an Ethernet broadcast domain by connecting sites through pseudo-wires. Example technologies that can be used as the transport over which pseudo-wires and VPLS services are provided include Ethernet over MPLS, L2TPv3, etc. Two IETF standards that track RFCs describing VPLS establishment include RFC 4761 “Virtual Private LAN Service (VPLS) Using BGP for Auto-Discovery and Signaling” and RFC 4762 “Virtual Private LAN Service (VPLS) Using Label Distribution Protocol (LDP) Signaling”.

VPLS is a virtual private network (VPN) technology which allows any-to-any (multipoint) connectivity. In a VPLS, the local area network (LAN) at each site is extended to the edge of the provider network. The provider network then emulates a switch or bridge to connect all of the customer LANs to create a single bridged LAN.

A VPLS creates an emulated LAN segment for a given set of users. It provides a layer 2 broadcast domain that is capable of learning and forwarding using Ethernet MAC addresses for a given set of users.

Today, Ethernet is the predominant technology used for Local Area Network (LAN) connectivity and is gaining acceptance as an access technology as well. This is true especially in Metropolitan Area Networks (MANs) and Wide Area Networks (WANs). In a typical scenario, an Ethernet port connects a customer to the Provider Edge (PE) device. Customer traffic is subsequently mapped to a specific MPLS-based Layer 2 Virtual Private Network (VPN).

Traditional LANs provide unicast, broadcast and multicast services. Locations that belong to the same broadcast domain and that are connected via an MPLS network expect broadcast, multicast and unicast traffic to be forwarded to the proper locations. This requires MAC address learning on a per LSP basis, forwarding unicast destination traffic according to the learned information, packet replication across LSPs for multicast/broadcast traffic and for flooding of unknown unicast destination traffic.

A main goal of Virtual Private LAN Services (VPLS) is to provide connectivity between customer sites situated in the MAN or WAN as if they were connected via a LAN. To accomplish this, a major attribute of Ethernet must be provided, namely the flooding of broadcast traffic, multicast traffic, and traffic with unknown destination MAC addressed to all ports. To provide flooding within a VPLS, all unicast unknown address, broadcast and multicast frames are flooded over the corresponding “pseudo-wires” to all relevant provider edge nodes that participate in the VPLS. Note that multicast packets are a special case and are not necessarily flooded to all VPN members. A pseudo-wire is a made up of a pair of unidirectional virtual circuit Label Switched Paths (LSPs). Throughout this document, the terms pseudo-wire and transport-entity are used to denote a point-to-point logical link connecting different nodes in the network, regardless of the technology used for its implementation, e.g., MPLS, etc. Depending on the technology, the pseudo-wire may be an MPLS-VC, a point-to-point Virtual LAN (VLAN)-based trail, an ATM-VC, etc.

A provider edge node uses different techniques to associate packets received from the client with connections. Example techniques include port mapping and VLAN mapping in which the received packet is associated with a connection according to the provider edge device port from which it was received or according to the port from which it was received as well as the VLAN with which it is tagged, respectively. Packets mapped to a VPLS connection, are forwarded to one or more of the sites associated with that particular VPLS connection. In case of a VPLS connection, the forwarding is performed by bridging-capable nodes throughout the network, that bridge between pseudo-wires dedicated to that VPLS. The pseudo-wires are point-to-point ‘sub-connections’ of that VPLS, functioning to connect the bridging-capable nodes. These bridging capable nodes must be able to first associate the received packet with a VPLS and then, within the context of the VPLS, associate a destination MAC address (or a destination MAC-address and VLAN-tag value) with a pseudo-wire comprising that VPLS in order to forward a packet. It is not practical to require these provider nodes to statically configure an association of every possible destination MAC address with a pseudo-wire. Thus, a bridging mechanism is required to dynamically learn MAC addresses (or MAC-address and VLAN pairs) on both physical ports and virtual circuits and to forward and replicate packets across both physical ports and pseudo-wires to which they are associated.

Provider edge (PE) devices participating in a VPLS-based VPN must appear as an Ethernet bridge to connected customer edge (CE) devices. Received Ethernet frames must be treated in such a way as to ensure CEs can be simple Ethernet devices. When a PE receives a frame from a CE, it inspects the frame and learns the source MAC address, storing it locally along with LSP routing information. It then checks the frame's destination MAC address. If it is a broadcast or multicast frame, or the MAC address is not known to the PE, it floods the frame to all PEs in the mesh.

Bridging functionality operates on the original Layer 2 portion of the packet. The bridge functions to learn new source MAC addresses of ingress packets and to associate them with the outbound pseudo-wire it is to be sent out on.

### SUMMARY

There is thus provided in accordance with the invention, a method of E-tree interoperability between E-domain devices incorporating bridging and VPLS-domain devices, the method for use on E-domain devices neighboring a VPLS-domain device, the method comprising segregating root traffic to a root-to-leaf VLAN, segregating leaf traffic to a leaf-to-root VLAN and performing asymmetric VLAN translation on traffic between the E-domain devices and the VPLS-domain devices.

There is also provided in accordance with the invention, a method of E-tree interoperability between E-domain devices incorporating bridging and VPLS-domain devices, the method for use on E-domain devices neighboring a VPLS-domain device, the method comprising segregating traffic between root endpoints in the E-domain and between the root endpoints in the E-domain and the VPLS domain to a root VLAN, segregating traffic from the VPLS domain destined to leafs in the E-domain to a root-to-leaf VLAN, segregating traffic originated by leafs destined to roots to a leaf-to-root VLAN, forwarding traffic between the root VLAN and root-to-leaf VLAN and leaf-to-root VLAN and performing asymmetric VLAN translation on traffic between the E-domain devices and the VPLS-domain devices.

There is further provided in accordance with the invention, an apparatus for E-tree interoperability between E-domain devices incorporating bridging and VPLS domain devices for use on E-domain devices neighboring a VPLS-domain device comprising a communications circuit operative to transmit and receive a traffic stream between an E-domain and a VPLS domain and segregating the traffic into separate root-to-leaf and leaf-to-root VLANs in the E-domain, a packet forwarder operative to forward traffic between the root and leaf VLANs wherein the VPLS domain receives traffic from a single VLAN in the E-domain and a translation module operative to perform asymmetric VLAN tag translation on traffic between the E-domain devices and the VPLS-domain devices.

There is also provided in accordance with the invention, an E-domain switch for use in providing an E-tree service, the E-domain device neighboring a VPLS domain device, the E-domain switch comprising a plurality of network ports for interfacing the switch to one or more communication links, a packet processor comprising an ingress packet processor and an egress packet processor, an E-tree interoperability module operative to segregate traffic between root endpoints in the E-domain and between the root endpoints in the E-domain and the VPLS domain to a root VLAN, segregate traffic from the VPLS-domain destined to leafs in the E-domain to a root-to-leaf VLAN, segregate traffic originated by leafs destined to roots to a leaf-to-root VLAN, forward traffic between the root VLAN and root-to-leaf and leaf-to-root VLANs and perform asymmetric VLAN translation on traffic between the E-domain devices and the VPLS-domain devices.

### BRIEF DESCRIPTION OF THE DRAWINGS

The mechanism is herein described, by way of example only, with reference to the accompanying drawings, wherein:

FIG. 1 is a diagram illustrating an example carrier Ethernet network architecture incorporating an MPLS core;

FIG. 2 is a diagram illustrating an example realization of an E-Tree service domain based on VPLS;

FIG. 3 is a diagram illustrating an example E-domain based E-Tree standalone ring;

FIG. 4 is a flow diagram illustrating an example E-Tree interoperability method of the present invention;

FIG. 5 is a diagram illustrating a first example realization of an E-Tree service based on VPLS where the leaf-to-root VLAN is used in the link connecting the E-domain and the MPLS domain;

FIG. 6 is a block diagram illustrating the ingress translation circuit portion of the E-domain device neighboring the MPLS domain;

FIG. 7 is a diagram illustrating a first example E-Tree service network utilizing the E-Tree interoperability circuit of the present invention;

FIG. 8 is a diagram illustrating an example E-Tree service for a dual-attached E-Domain;

FIG. 9 is a diagram illustrating a second example realization of an E-Tree service based on VPLS where the root-to-leaf VLAN is used in the link connecting the E-domain and the MPLS domain;

FIG. 10 is a block diagram illustrating the egress translation circuit portion of the E-domain device neighboring the MPLS domain;

FIG. 11 is a diagram illustrating an example realization of an E-Tree service domain based on VPLS incorporating roots as well as leafs in the same E-domain; and

FIG. 12 is a functional block diagram illustrating an example E-domain switch incorporating the E-tree interoperability mechanism of the present invention.

### DETAILED DESCRIPTION

The mechanism will now be described more fully hereinafter with reference to the accompanying drawings, in which preferred embodiments of the mechanism are shown. The mechanism may, however, be embodied in many different forms and should not be construed as limited to the embodiments set forth herein. Rather, these embodiments are provided so that this disclosure will be thorough and complete, and will fully convey the scope of the mechanism to those skilled in the art. Like numbers refer to like elements throughout, and prime notation is used to indicate similar elements in alternative embodiments.

To aid in illustrating the principles of the mechanism, an example network is presented in connection with the E-Tree interoperability translation mechanism. An example embodiment is provided to illustrate the fast protection mechanism of the present invention. It is not intended, however, that the mechanism be limited to the configurations and embodiments described herein. It is appreciated that one skilled in the networking, electrical and/or software arts may apply the principles of the mechanism to numerous other types of networking devices and network configurations as well, including other types of synchronous data streams and asynchronous transport networks without departing from the scope of the mechanism.

Many aspects of the mechanism described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

Throughout this document, the terms packet and frame are used interchangeably and are intended to denote a protocol data unit (PDU) adapted to transport data and/or control information from one point to another. References are made to Ethernet frames, IP packets, etc. which are example protocol data units (PDUs) associated with various networks such as Ethernet, H.323, ISO OSI TCP/IP protocol stack. It is appreciated, however, that the mechanism may be adapted for use in other types of networks that transmit other types of PDUs as well. The principles of MAC based transmission as described herein are not limited to Ethernet MAC devices and can be applied to other types of Layer 2 protocols and devices as well.

The most popular types of VPLS-spokes are VLAN-spokes and MPLS-spokes. A VLAN spoke is a spoke site that resides in a non-MPLS, VLAN enabled network device (e.g., according to IEEE 802.1Q or 802.1ad). A MPLS spoke is a spoke site that resides in an MPLS enabled network device. Such a spoke is connected to one or two VPLS VSIs through MPLS transport entities (e.g., pseudo-wires).

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media.

The word ‘exemplary’ is used herein to mean ‘serving as an example, instance, or illustration.’ Any embodiment described herein as ‘exemplary’ is not necessarily to be construed as preferred or advantageous over other embodiments.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the mechanism, discussions utilizing terms such as ‘processing,’ ‘computing,’ ‘calculating,’ determining, ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices or to a hardware (logic) implementation of such processes.

The flowchart and block diagrams in the Figures illustrate the architecture, functionality, and operation of possible implementations of systems, methods and computer program products according to various embodiments of the present mechanism. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Note that the mechanism can take the form of an entirely hardware embodiment, an entirely software embodiment or an embodiment containing a combination of hardware and software elements. In one embodiment, a portion of the mechanism can be implemented in software, which includes but is not limited to firmware, resident software, object code, assembly code, microcode, etc.

Furthermore, the mechanism can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (embedded or removable in the form of, e.g., USB flash drive, SDIO module, etc.), ROM, EPROM, or other semiconductor memory devices.

### Example Carrier Ethernet Network

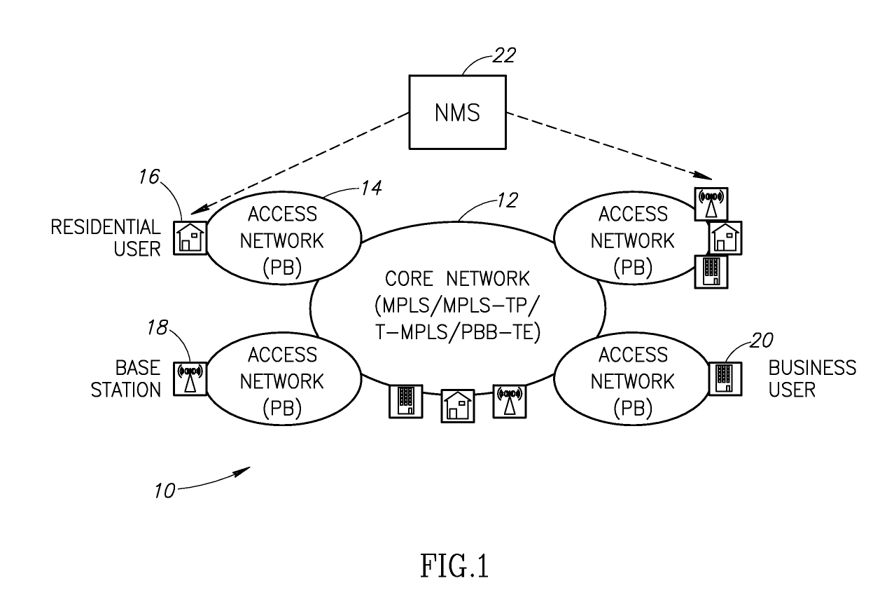

A diagram illustrating an example carrier Ethernet network architecture incorporating an MPLS core is shown in FIG. 1. The example Carrier Ethernet Network (CEN), generally referenced 10, comprises a core network 12 and a plurality of access networks 14 connecting users such as residential 16, base stations 18 and business users 20. The core network 12 may use various technologies such as MPLS, MPLS-TP, T-MPLS or PBB-TE. The access network usually comprises Provider Bridging (PB), also known as Q-in-Q. Note that throughout this document, the term E-domain is used to refer to PB based access-networks.

The Metro Ethernet Forum (MEF) defines three types of carrier Ethernet services, namely E-Line, Ethernet Local Area Network (E-LAN) and Ethernet Tree (E-Tree) service, which can be implemented via various underlying technologies, such as VPWS, VPLS, Provider Bridging and PBB-TE, etc.

The E-Tree service (described in more detail in MEF 6.1 and MEF 10) is the service described by MEF as a ‘rooted multipoint EVC’, similar to an E-LAN service which is described by MEF as a ‘multipoint-to-multipoint EVC’. In operation, E-Tree service provides connectivity between End Points defined as ‘leaves’ and End Points defined as ‘Roots’ or between End Points that are defined as ‘Roots’. E-Tree service, however, denies connectivity between End Points defined as ‘Leaves’. Thus, leaves can communicate with roots, roots can communicate with leaves and roots can communicate with other roots, but leaves cannot communicate with other leaves. In other words, ingress service frames at a Root UNI can be delivered to one or more of any of the other UNIs in the service. Ingress service frames at a Leaf UNI can only be delivered to one or more Root UNIs of the service. In addition, a single E-Tree service may have more than one root.

VPLS-based implementation of E-tree services will now be described. RFC 4762 “Virtual Private LAN Service (VPLS) Using Label Distribution Protocol (LDP) Signaling” and RFC 4761 “Virtual Private LAN Service (VPLS) Using BGP for Auto-Discovery and signaling” are IETF standards that define the VPLS service and its implementation. These two standards define two different versions of VPLS implementation, the difference being mainly in the signaling protocols and in the auto-discovery procedures (i.e. discovering the peers in the same VPLS).

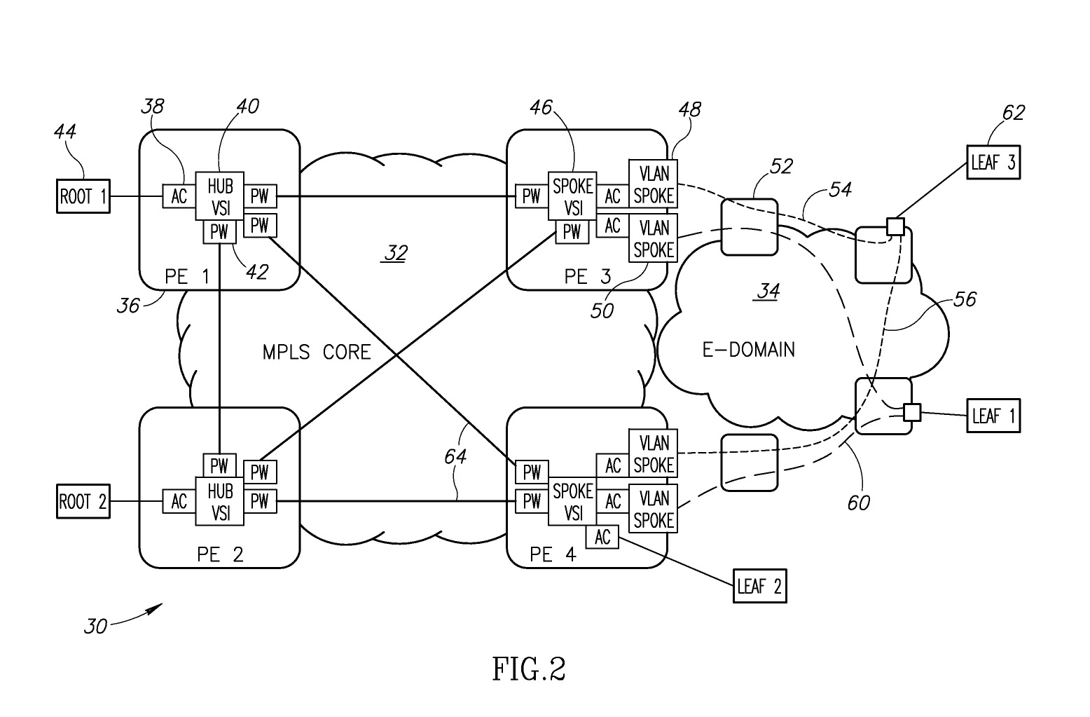

A VPLS service is constructed of Virtual Switch Instances (VSIs) placed on one or more MPLS PE devices. In accordance with RFC 4762, a full mesh of Pseudo-Wires (PWs) between the VSIs provides full connectivity between them in order to provide E-LAN functionality. Endpoints of the service either reside on the PE devices or connected to the VSI through the network, for example through a point-to-point VLAN-spoke. Note that when leaf and root endpoints residing on an E-domain need to be connected to a VPLS, the current method used referred to as VLAN-spoke. Using the VLAN-spoke method, each endpoint is separately connected by a VLAN-based point-to-point connection to a VSI of the VPLS. If protection is required, two disjoined point-to-point VLAN-based connections connect the endpoint to the VPLS. VLAN-spokes are illustrated on the right-hand side of FIG. 2, connecting leaf 1 and leaf 3 to the VPLS-based E-tree.

The VPLS-spokes method, however, is not efficient, especially when the service includes multicasting from the roots to leaves. This is because the multicast traffic needs to be replicated at the egress from the VSI to each and every endpoint separately, through its own VLAN-spoke based connection. This fact makes the VLAN-spoke method unusable for applications like IP-TV distribution.

A diagram illustrating an example realization of an E-Tree service domain based on VPLS is shown in FIG. 2. The example network, generally referenced 30, comprises an MPLS core 32 connected to an E-domain network 34. The MPLS core comprises a plurality of MPLS provider edge (PE) switches 36 connected in almost full mesh via Pseudo-Wires (PWs). The MPLS-core network may also contain P (Provider) LSR (Label Switch Router) devices through which the MPLS tunnels (LSPs) carrying the PWs flow. Each MPLS-PE comprises a Virtual Switch Instance (VSI) 40, 46, PW interfaces 42 and Attachment Circuits (ACs) 38. The MPLS-PEs are divided into devices with Hub VSIs (left side) and Spoke VSIs (right side). Note that the Hub VSI is also referred to as a Root VSI and Spoke VSI is also referred to as Leaf VSI.

The network 30 is an example implementation of an E-Tree based on VPLS which is similar to an implementation of an E-LAN based on VPLS. At the E-Domain, configuration and operation of the VLAN spokes are the same in both E-Tree and E-LAN. Two types of VSIs are defined in the MPLS domain. One type is the Spoke VSI 46 which are connected to Leaf End Points but not to Root End Points and do not allow forwarding between ACs. The second type is the Hub VSI which is connected to Root End Points but not to Leaf End Points. Hub VSIs can connect to all other VSIs and do allow forwarding between ACs. A Spoke VSI connects only to Hub VSIs and does not allow traffic switching between VLAN spokes that are connected to it, while a Hub VSI allows such traffic switching. Further, in order to avoid communication between the “Spoke VSIs”, PWs are not configured between Spoke VSIs, hence the partial mesh.

The E-domain 34 comprises a plurality of E-domain devices (e.g., switches) 52 connected to one or more leaves 62. The E-domain devices are connected via one or more working and protection VLAN spokes 54, 56, 58, 60. Note that with existing VPLS implementations, in the event the E-tree service comprises a VPLS with only a single VSI on a single PE device, it is possible to support both root and leaf endpoints connected to that VSI, and even belonging to the same E-domain.

Virtual Switching Instances (VSIs) are maintained by the MPLS core switches and function to deliver layer 2 VPNs, VPLS. VSIs maintain MAC address (or MAC-address and VLAN) entries for a particular VPLS. In a VSI, MAC addresses (or MAC-address and VLAN pairs) are learned on transport entities (e.g., pseudo-wires, VLAN-trails) (just as a Layer 2 switch learns MAC addresses on ports).

The VPLS spokes and the VSIs on core switches are interconnected via transport entities (e.g., pseudo-wires, VLAN-trails) and provide a layer-2 VPN service that appears as a single emulated LAN to the user site stations. The core switches interconnect access-devices (E-domain devices) as well as directly-connected user sites, and provide bridging therebetween. Access devices may also contain a bridging function between their UNIs and the pseudo-wires/transport-entities belonging to the VPLS. Each device having VPLS bridging functionality is adapted to learn remote MAC address (or MAC address and VLAN tag) to pseudo-wire/transport-entity associations from traffic received over these pseudo-wires/transport-entities and to also learn source MAC address to user port associations from traffic received over user ports.

Note that the mechanism of the invention is applicable in general to VPLS domains and VPLS domain devices. For illustration purposes only, network examples are provided showing MPLS domains and MPLS domain devices as examples of VPLS domain and domain devices, respectively.

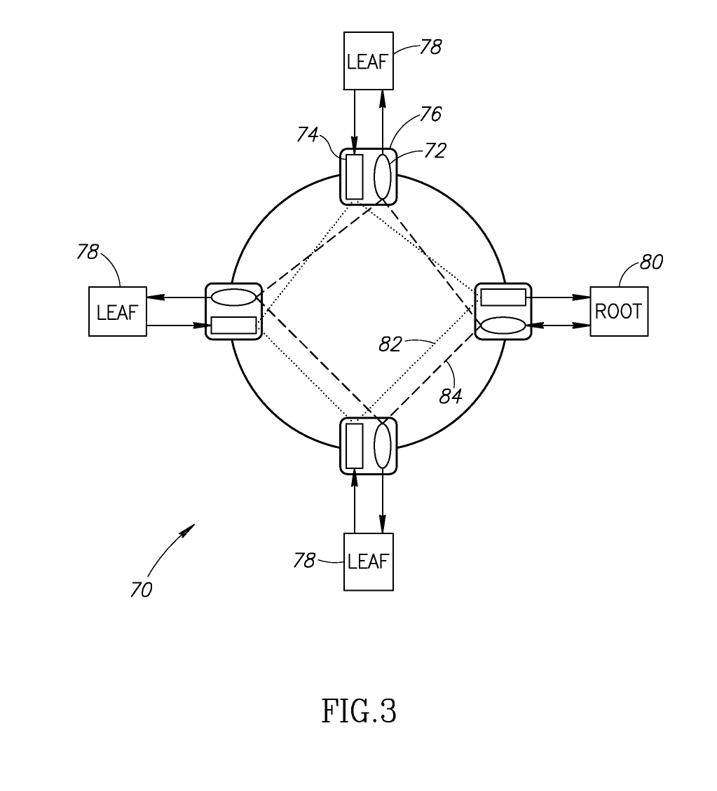

The E-Tree service at a stand-alone E-Domain (i.e. one that is not connected to another domain like an MPLS domain) is realized using two S-VLANs as compared to a single S-VLAN in a regular E-LAN service, example of such a network can be seen in FIG. 3. The two S-VLANS are referred to as “Root S-VLAN Identifier (VID)” and “Leaf S-VID”. Packets received from End Points defined as “Roots” are encapsulated with a “Root S-VID” while packets received from End Points defined as “Leaves” are encapsulated with a “Leaf S-VID”.

Since a single E-Tree service is realized by two S-VLANs, MAC learning must be performed on both VLANs. In addition to the learning done on the S-VID of the packet, learning should also be performed on the ‘other’ VLAN. In other words, packets arriving with a “Root S-VID” should also be learned on the “Leaf S-VID” and vice versa. This constitutes a ‘Shared VLAN Learning’ (SVL) scheme for the pair of VLANs. The forwarding of packets that carry the “Root S-VID” is allowed to all end-points. The forwarding of packets that carry the “Leaf S-VID”, however, is allowed only to root end points.

A diagram illustrating an example E-domain based E-Tree standalone ring is shown in FIG. 3. The stand-alone ring is an example of an E-domain topology. The solution is actually applicable to E-domains of any topology. The example E-domain, generally referenced 70, comprises a plurality of E-domain devices 76 configured in a ring structure. These devices serve as example provider-bridge (IEEE 802.1ad) devices, supporting VLAN-based E-tree service. Each device comprises a root VSI 72 and a leaf VSI (no local switching allowed). Root VSIs are connected via root S-VLAN 84 and leaf VSIs are connected via a leaf S-VLAN 82. Three devices are shown connecting a leaf 78 while one of the devices is connected to a root 80.

When the E-Tree is realized using VSIs on the MPLS-PE devices and VLANs on the E-Domains, both components, the VSIs and the VLANs, ideally should participate in denying connectivity between Leaf End Points. Further, using the bridged VLAN-based E-tree in the E-domain is very efficient (in comparison to an E-LAN service based on VPLS-spokes in the E-domain, as shown in FIG. 2) when the service includes multicasting from the roots to leaves, since the multicast traffic is not replicated at the egress from the VSI but only at the targeted network-elements.

Similar to the E-Tree based on VLAN spokes, in the Bridging case, each PE-device is defined as either Hub or Spoke VSI (as shown in FIG. 2). For Hub VSIs (i.e. hosting only Roots), only the “Root S-VID” is used in the attached E-Domains. The PE-device sends and receives traffic to/from the attachment-circuit with “Root S-VID”. For Spoke VSIs (hosting only Leaves), both “Root-to-leaf S-VID” and “Leaf-to-root S-VID” attachment circuit are required. Traffic from the roots is sent by the VSI at the PE-device to the “Root-to-leaf S-VID” (to allow leaves to be able to receive them), and Traffic from the leaves is sent to the “Leaf-to-root S-VID”. Roots and leafs can co-exist in the same E-domain (described infra) by using the three VLANs concurrently, including: (1) the “Root VLAN” used for connecting to root-endpoints; (2) the “root-to-leaf VLAN” used to convey root-originated traffic from the VSI to leaf endpoints; and (3) the “leaf-to-root VLAN” used to convey traffic from leaf-endpoints to the VSI which will then forward them to the root-endpoints.

This causes a problem, however, with the MAC learning mechanism, which cannot be handled by current PE-devices, since the VPLS implementation of many MPLS-PE devices maintain a separate learning database per-VLAN, and therefore do not share the learning information between the two VLANs as required in the VLAN-based E-tree solution. In other words, the current E-tree VPLS-based implementation and the current PB/VLAN-based implementation of E-tree are not interoperable and cannot be combined.

The E-tree interoperability translation mechanism of the present invention provides a solution for E-tree interoperability between E-domain devices and existing MPLS-PE devices. No changes to the MPLS-PE devices are required with changes required only to the E-domain devices. In this manner, the mechanism retains wide applicability and is interoperable with any MPLS-PE device. Note that only those E-domain devices directly connected to the MPLS-PE devices need to be modified to implement the mechanism of the present invention. Thus, all other devices in the E-domain may comprise any IEEE-802.1 compliant devices.

In order to overcome the issues described above and provide the E-Tree functionality in a network incorporating E-domains with bridging and an MPLS domain with VPLS, the E-domain device that directly connected to the MPLS-PE device is modified to perform an asymmetric VLAN tag manipulation on traffic forwarded between the MPLS-PE device and itself. The capabilities of VPLS are used to divide between roots and leaves, even if both exist in the same E-domain, so that they do not share VLANs (unlike the E-domain E-tree scheme described above in connected with FIG. 3). The result is that roots and leaves in the same E-domain do not communicate directly, but through the MPLS-PE devices to which the E-domain connects.

It is appreciated that the mechanism of the present invention is useful in networks constructed of MPLS and E-domains, and which need to provide an E-tree service. The mechanism is especially applicable in E-tree services used primarily for transporting multicast traffic. Currently, MPLS and E-domains is a very common structure of many metro networks, Carrier Ethernet networks and mobile-backhaul networks. E-tree is commonly used in such networks whose applications include, for example, connecting homes to a service provider (including a multicast-based IP-TV service provider), connecting cell-devices to gateways in mobile-backhaul networks and connecting branches to the headquarters in business applications.

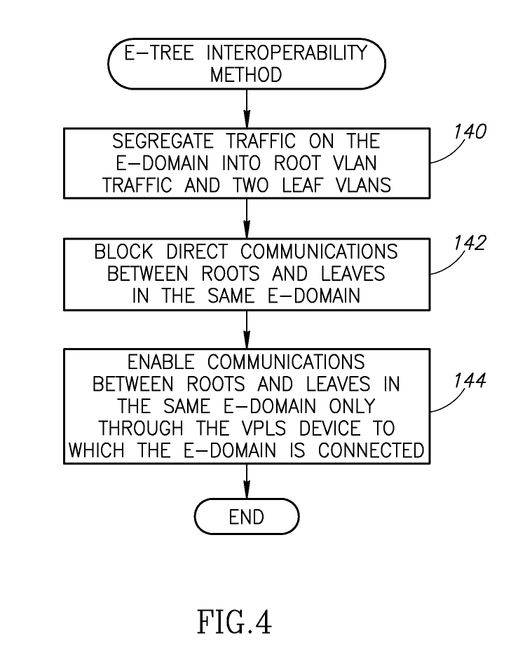

A flow diagram illustrating an example E-Tree interoperability method of the present invention is shown in FIG. 4. As a first step, traffic on the E-domain is segregated into root VLAN traffic and two leaf VLANs (step 140). One leaf VLAN handles ingress traffic originated by the leafs destined to roots (called the “leaf-to-root VLAN” throughout this document) and a second leaf VLAN handles egress traffic from roots destined to the leafs (called the “root-to-leaf VLAN”). Direct communications between roots and leafs in the same E-domain are blocked (step 142). Communications between roots and leaves in the same E-domain is enabled only through the VPLS device to which the E-domain is connected (step 144).

For illustrative purposes only, the description first focuses on a single E-Domain that comprises only leaf end-points. Even though only leaf endpoints are present in such an example E-domain, two VLANs are still required: (1) one, called the “root-to-leaf VLAN”, for forwarding traffic from roots (i.e. that originated outside of the E-domain and needs to be forwarded to it through the VPLS), and (2) one, called the “leaf-to-root VLAN”, for forwarding traffic originated by leaves belonging to the E-domain. Two embodiments are presented below.

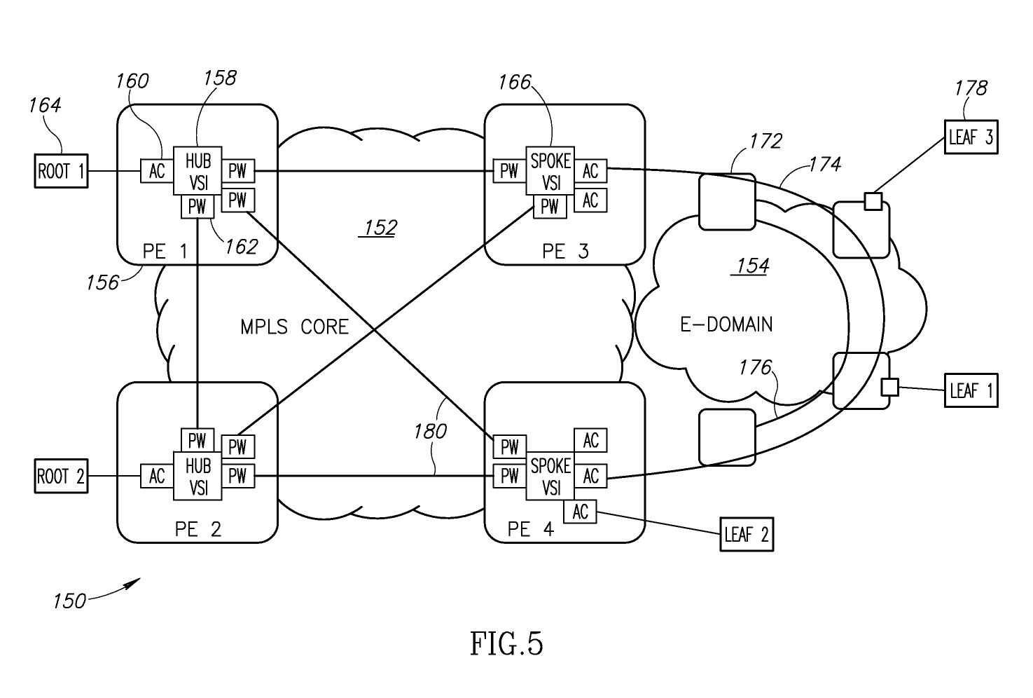

In a first embodiment, a diagram illustrating a first example realization of an E-Tree service based on VPLS where the leaf-to-root VLAN is used in the link connecting the E-domain and the MPLS domain is shown in FIG. 5. The example network, generally referenced 150, comprises an MPLS core 152 connected to an E-domain network 154. The MPLS core comprises a plurality of MPLS provider edge (PE) switches 156 connected in almost full mesh via Pseudo-Wires (PWs). Each MPLS-PE comprises a Virtual Switch Instance (VSI) 158, 166, PW interfaces 162 and Attachment Circuits (ACs) 160. The MPLS-PEs are divided into devices with Hub VSIs (left side) and Spoke VSIs (right side). Roots are connected to the MPLS core via Hub VSIs 158 and leafs are connected to E-devices 172 in the E-domain 154, as well as directly to the spoke VSIs (e.g. leaf 2). The E-domain 154 comprises a plurality of E-domain devices (e.g., switches) 172 connected to one or more leaf 178.

In this first embodiment, the MPLS PE-device is configured with a single VLAN, i.e. only with the “Leaf-to-root S-VID” VLAN 174, which solves the MAC learning issue. The E-domain leaf endpoints are configured as described supra in the stand-alone E-domain scheme, i.e. they are configured to send the traffic tagged with the leaf-to-root S-VLAN, while only receiving traffic from the root-to-leaf S-VID VLAN 176.

The E-domain device connected to the MPLS-PE device is adapted to perform asymmetric address translation of the “Leaf-to-root S-VID” in frames coming from the PE to the “Root-to-leaf S-VID”. In this manner, the traffic from the PE, which comprises traffic originated only by roots, is forwarded at the E-Domain with the Root-to-leaf S-VID, and therefore is forwarded to the leaf-endpoints after asymmetric address translation via the root-to-leaf VLAN 176. Traffic originated in leaf endpoints is forwarded as is, and therefore is received by the PE device with the leaf-to-root S-VLAN 174 (which is the only VLAN that it expects to get leaf-originated traffic from). Along with appropriate configuration in the VSI (as described supra), leaves will not communicate with each other.

Note that the E-domain device preferably performs the VLAN-translation from Leaf-to-root S-VID to root-to-leaf S-VID only on ingress frames directly received from the link connected to the PE device. This translation is preferably performed before any switching or bridging processing or decision making is made with the frame.

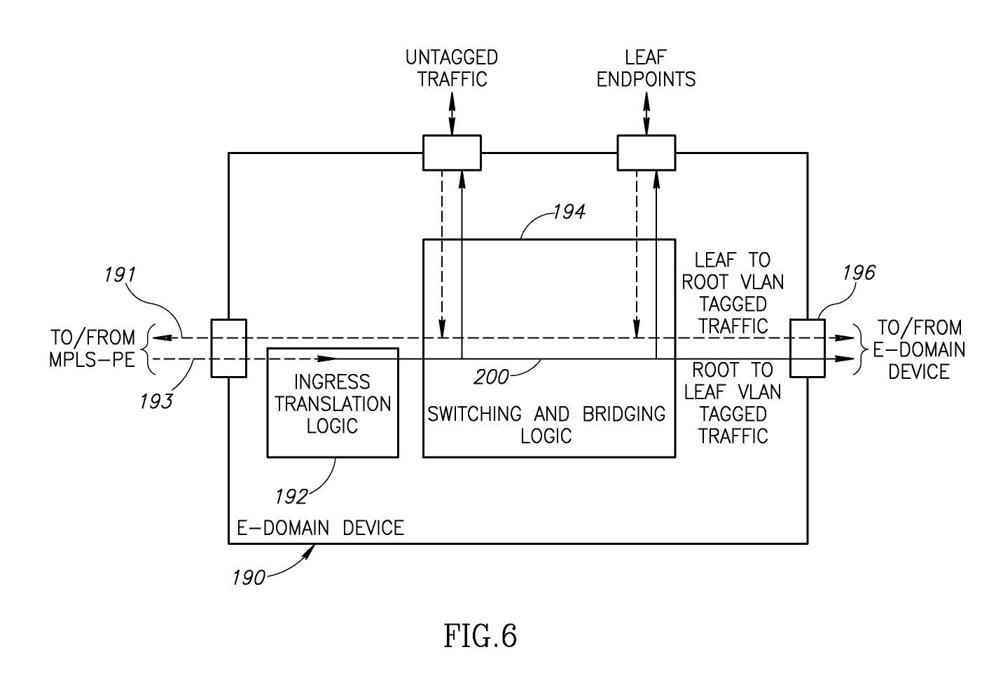

A block diagram illustrating the ingress translation circuit portion of the E-domain device neighboring the MPLS domain is shown in FIG. 6. The E-domain device, generally referenced 190, comprises switching and bridging logic 194, ingress translation logic 192 and a plurality of ports 196. As described supra, ingress leaf-to-root VLAN tagged traffic from the MPLS-PE device via VLAN 193 is asymmetrically translated (i.e. only on ingress) via logic 192 to root-to-leaf VLAN tagged traffic destined for leaf endpoints over root-to-leaf VLAN 200. Root-to-leaf VLAN tagged traffic is forwarded to other E-domain devices on the E-domain. Leaf-to-root VLAN tagged traffic originated by leaf endpoints passes intact and is forwarded to the MPLS-PE device via VLAN 191

It is appreciated that the mechanism is not limited to operation in the neighboring VPLS-domain device as the mechanism will also operate if the VSI that performs the operation is not placed in the neighboring VPLS-domain device.

The ingress translation logic uses a translation table such as the example table presented below to perform the asymmetric translation. The translation table can be implemented using an array of 4096 entries (i.e. 12-bit VLAN tag). The key to the table array is the original VLAN tag in the frame and the value read out is the new VLAN tag that should over-write the original one before the frame is sent on.

In the example translation table below, VLAN 3 gets translated to VLAN 5, meaning that original frames that have VLAN 3 will be modified to have VLAN 5 instead before being forwarded on. Note that a similar table and description applies for both the ingress translation table as well as for the egress translation table (described in the second embodiment infra).

TABLE 1
Example Ingress Translation Table

| Key | Value |
|---|---|
| 1 | 1 |
| 2 | 2 |
| 3 | 5 |
| 4 | 4 |
| 5 | 5 |
| 6 | 6 |
| . . . | . . . |
| 4096 | 4096 |

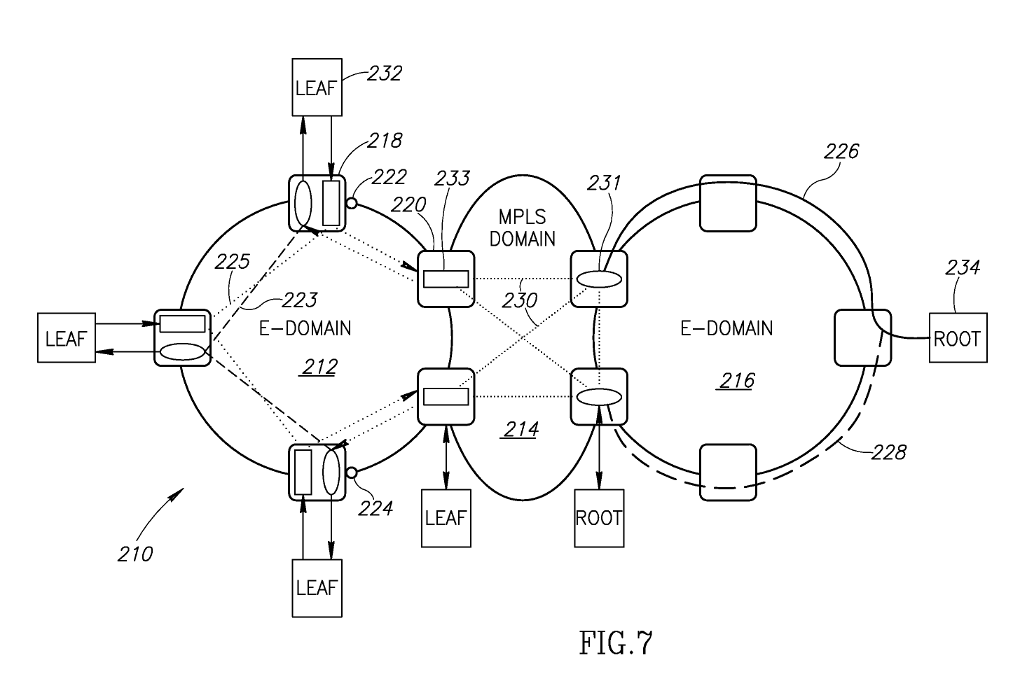

A diagram illustrating a first example E-Tree network utilizing the E-Tree interoperability circuit of the present invention is shown in FIG. 7. The example E-tree network, generally referenced 210, comprises E-domains 212, 216 and MPLS core domain 214. The MPLS domain comprises PE devices 220, pseudo wires 230, leaf VSIs 233 (with no local switching) and root VSIs 231. The E-domains comprise E-domain devices 218 connected to leafs 232 and roots 234. Dashed lines 223 indicate root-to-leaf S-VLAN while dotted lines 225 indicate leaf-to-root S-VLAN. Translation points 222 and 224 indicate an S-VLAN translation point wherein S-VLAN to root-to-leaf S-VLAN translation is performed in the ingress direction.

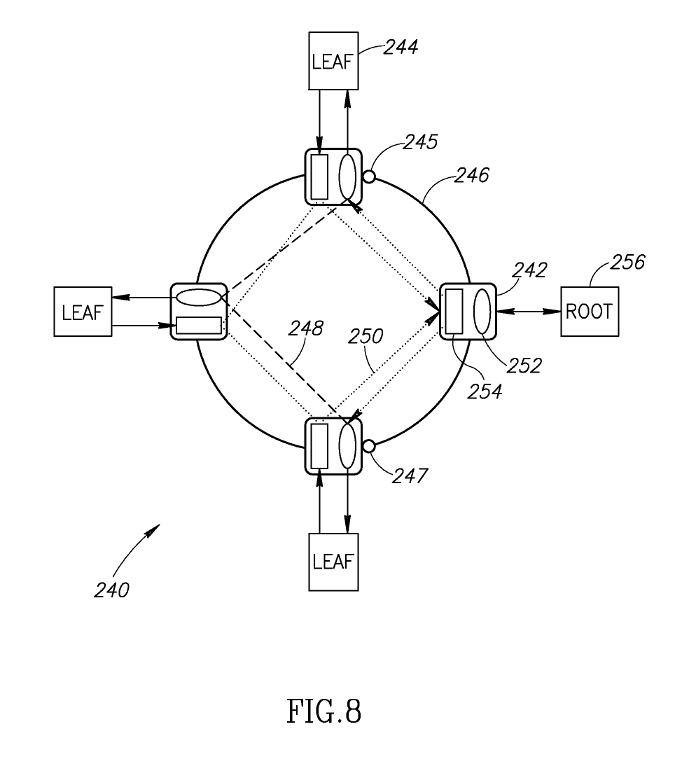

A diagram illustrating an example E-Tree for a dual-attached E-Domain is shown in FIG. 8. In this example, generally referenced 240, the roots 256 and leaves 244 are connected to the same MPLS-PE device 242 in a ring structure 246. The ring comprises leaf VSIs 254 (with no local switching) and root VSIs 252. Dashed lines 248 indicate root-to-leaf S-VLAN while dotted lines 250 indicate leaf-to-root S-VLAN. Translation points 245 and 247 indicate an S-VLAN translation point wherein S-VLAN to root-to-leaf S-VLAN translation is performed in the ingress direction.

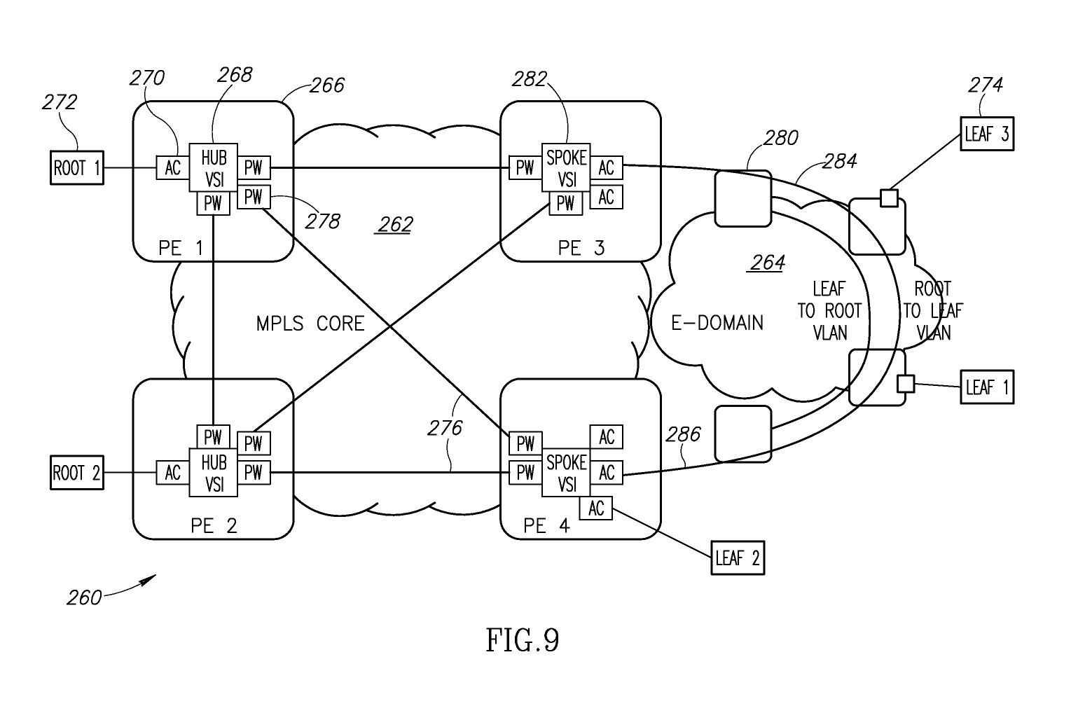

A diagram illustrating a second example realization of an E-Tree service based on VPLS where the root-to-leaf VLAN is used in the link connecting the E-domain and the MPLS domain is shown in FIG. 9. The example network, generally referenced 260, comprises an MPLS core 262 connected to an E-domain network 264. The MPLS core comprises a plurality of MPLS provider edge (PE) switches 266 connected in almost full mesh via Pseudo-Wires (PWs). Each MPLS-PE comprises a Virtual Switch Instance (VSI) 268, 282, PW interfaces 278 and Attachment Circuits (ACs) 270. The MPLS-PEs are divided into devices with Hub VSIs (left side) and devices with Spoke VSIs (right side). Roots are connected to the MPLS core via Hub VSIs 268 and leafs are connected to E-devices 280 in the E-domain 264. The E-domain 264 comprises a plurality of E-domain devices (e.g., switches) 280 connected to one or more leafs 274. Leafs can also connect directly to the spoke VSIs (e.g., leaf 2).

In this second embodiment, the MPLS-PE device is again configured with only a single S-VID, but rather than be configured with the leaf-to-root VID as in the first embodiment, it is configured with only the “Root-to-leaf S-VID” VLAN 284. The E-domain device connected to the PE device, translates in asymmetric fashion the “Leaf-to-root S-VID” in egress frames transmitted via the leaf-to-root VLAN 286 towards the MPLS-PE to a “Root-to-leaf S-VID” VLAN 284. In this manner the traffic from the E-domain devices which only originates from leafs via leaf-to-root VLAN 286, arrives to the MPLS-PE with the Root-to-leaf S-VID. Along with appropriate configuration in the VSI, leaves will not communicate with each other.

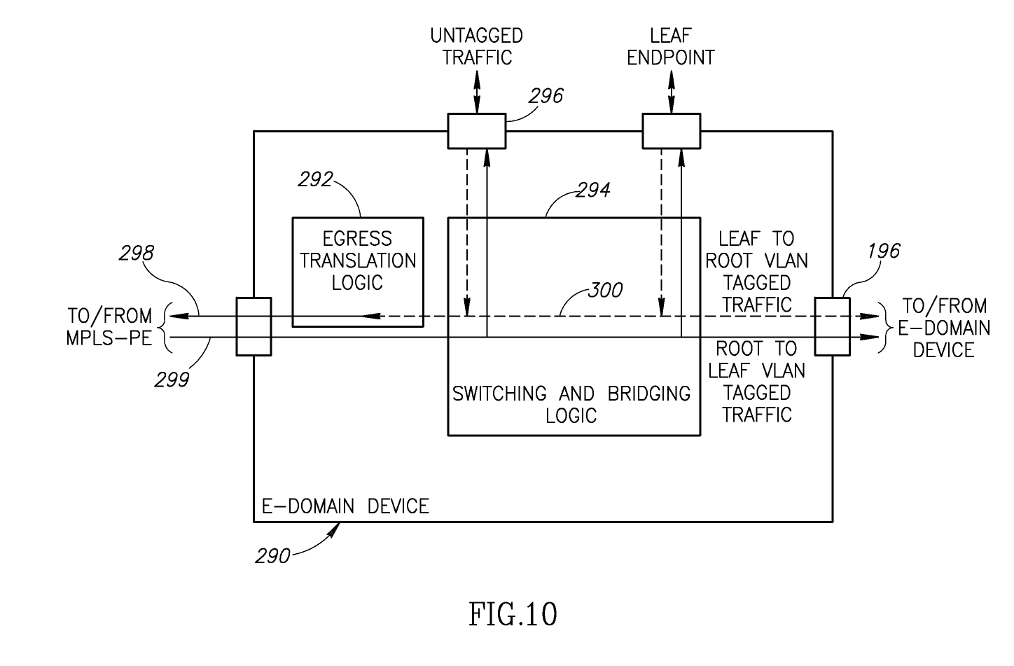

A block diagram illustrating the egress translation circuit portion of the E-domain device neighboring the MPLS domain is shown in FIG. 10. The E-domain device, generally referenced 290, comprises switching and bridging logic 294, egress translation logic 292 and a plurality of ports 296. As described supra, egress leaf-to-root VLAN tagged traffic (300) from the E-domain device is asymmetrically translated (i.e. only on egress) via logic 292 to root-to-leaf VLAN tagged traffic destined for roots over root-to-leaf VLAN 298 via MPLS-PE devices. Leaf-to-root VLAN tagged traffic from leaf endpoints on other E-domain devices on the ring is forwarded similarly. Root-to-leaf VLAN tagged traffic originated by roots (VLAN 299) from MPLS-PE devices passes intact and is forwarded over the root-to-leaf VLAN 299 to leaf endpoints.

The egress translation logic uses a translation table such as the example Table 1 presented supra to perform the asymmetric translation. The translation table can be implemented using an array of 4096 entries (i.e. 12-bit VLAN tag). The key to the table array is the original VLAN tag in the frame and the value read out is the new VLAN tag that should over-write the original one before the frame is sent on.

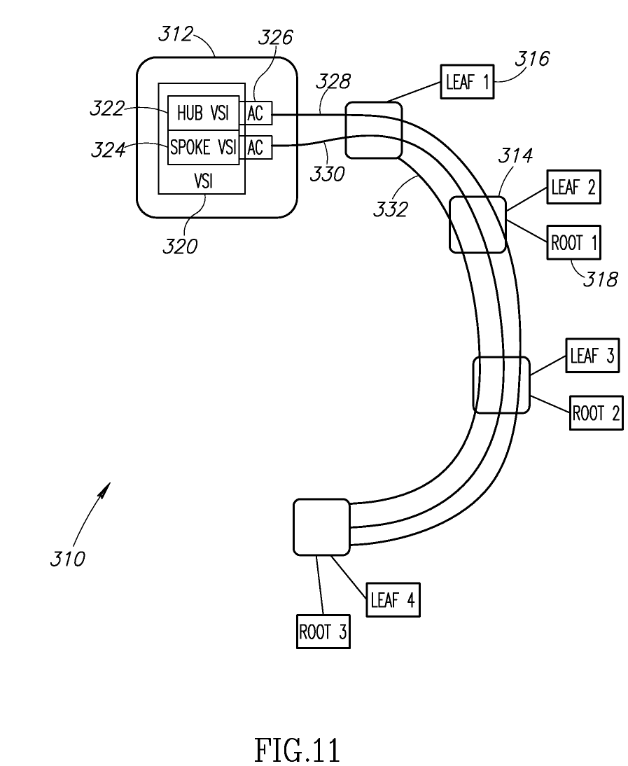

A diagram illustrating a third example realization of an E-Tree service domain based on VPLS incorporating roots as well as leafs in the same E-domain is shown in FIG. 11. The example realization, generally referenced 310, comprises an MPLS-PE core switch 312 and a plurality of E-domain switches 314 connected to leafs 316 and roots 318 on the same E-domain. The PE 312 comprises a VSI 320 which comprises functionally separate hub (or root) VSI 322 and spoke (or leaf) VSI 324. Note that how the hub and spoke VSIs are implemented, e.g., together in the same VSI or in separate VSIs is not critical, as long as the traffic passes between them in the same way as it passes between VSIs in different devices which are connected through a PW.

The scheme for interoperability between a VPLS-based E-tree and E-domain E-tree described supra can be further enhanced to allow root and leaf endpoints to reside in the same E-domain. This is shown in a third embodiment by adding a third bridged VLAN to the E-domain, to which all root endpoints are connected; or by adding two 1:1 disjoined point-to-point VLAN spokes, protecting each other, for each root endpoint. The VPLS is responsible to bridge between this VLAN(s) and the leaf-endpoints VLAN. This is possible with the current VPLS standards when only one VSI is used (in which case this VSI can support root and leaf endpoints concurrently). If a scheme that connects endpoints to remote VSIs is used, each E-domain can be connected to that single VSI even if not directly connected to the MPLS holding this VSI.

In the example realization of FIG. 11, the three VLANs comprise: (1) a root VLAN 328 for traffic between root endpoints in the E-domain and between the root endpoints in the E-domain and the VPLS domain; (2) a root-to-leaf VLAN 332 for egress traffic from the VPLS domain destined to leafs in said E-domain; and (3) a leaf-to-root VLAN 330 for ingress traffic originated by leafs destined to roots. Traffic is forwarded by the VSI between the root VLAN and root-to-leaf VLAN and leaf-to-root VLAN. The neighboring E-domain device performs asymmetric VLAN translation on traffic between said E-domain devices and said VPLS-domain devices.

E-Tree Interoperability Enhanced E-Domain Switch Device Embodiment

An E-domain switch device can be adapted to incorporate the E-tree interoperability translation mechanism. Hardware means and/or software means adapted to execute the mechanism may be incorporated within a network device, typically the E-domain switch bordering the MPLS domain. It is appreciated that the mechanism may also be implemented in a core switch, provider edge switch, Network Management System, Label Switching Router (LSR), Ethernet LAN switch, network switch or any other wired or wireless network device. The device may be constructed using any combination of hardware and/or software.

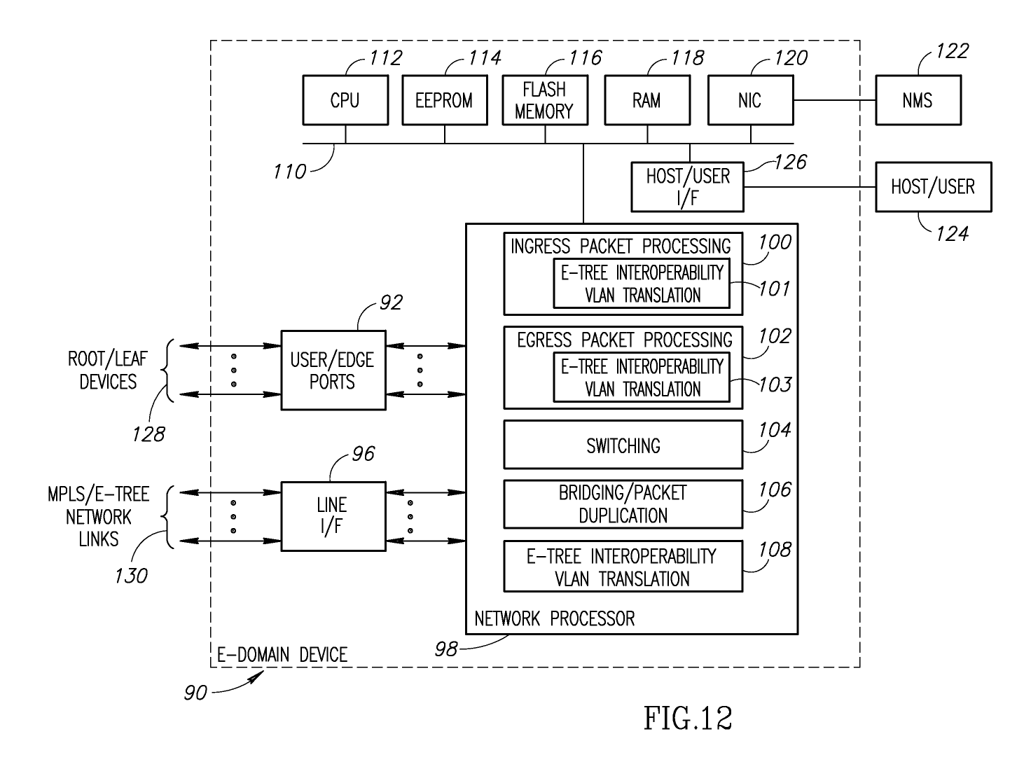

A block diagram of an example E-domain device incorporating the E-tree interoperability translation mechanism of the present invention is shown in FIG. 12. The E-domain device, generally referenced 90, comprises at its core a network processor 98, link or network interface ports 96, edge or user ports 92, a network interface 120 for interfacing the provider edge switch to an NMS 122, a central processor 112, e.g., CPU, and both volatile and non-volatile memory including RAM memory 118 for storing data and application program code, Flash memory 116 for storing boot and application code and EEPROM 114 for storing configuration data. The CPU communicates to the network processor, memory peripherals and other support devices via a bus 110.

The switch 90 comprises a user side and a network side. The one or more line interface cards containing network ports 96 provide the PHY interface to two-way communication links 130. As an example, the line interface cards may be adapted to interface to any combination of the following communication links: any variety of copper or optical based Ethernet, Token Ring, FDDI, SONET/SDH, ATM, RPR, etc.

A plurality of edge ports 92 is provided for connecting directly or indirectly to any number of root and leaf devices via links 128. The edge ports interface to the root or leaf device via any suitable type of interface, e.g., Gigabit Ethernet (GE), Fast Ethernet (FE), LOGE, SONET/SDH, PDH interface (e.g., T1/E1), etc. Likewise, the network side interfaces to MPLS domain devices and/or other E-Domain devices via any suitable interface such as Optical Ethernet (e.g., 1GE, 10GE, etc.), TDM SONET/SDH/PDH, RPR, etc.

A plurality of switches may be connected to each other to form an E-domain whereby one or more of the switches are connected to MPLS core switches, and adapted together to provide an E-tree service. In this case, connections may be built using VPLS over MPLS based technology. Alternatively, the E-Tree service may be provided by a network comprising a single MPLS switch and a plurality of E-domain devices connecting any number of roots and leafs, and arranged in any topology.

The network processor 98 implements the switching fabric (switching block 104) for providing the switching functionality of the device. Depending on the specific implementation, the switching fabric may comprise, for example, hardware for performing VLAN tagging, MPLS, Frame Relay, ATM switching, CSIX or any other fabric to network interface protocol. The network processor includes one or more packet processing engines (PPE) that comprises an ingress packet processor 100 and an egress packet processor 102. The network processor also comprises timestamp circuits, clock circuits, memory, counters and CPU interface (not shown), means for performing OAM protocol (e.g., ITU Y.1731, IEEE 802.1ag, etc.) processing (part of this capability may reside in the CPU as well). The network processor may be implemented as a microcontroller, microprocessor, microcomputer, ASIC core, FPGA core, central processing unit (CPU) or digital signal processor (DSP) or any other suitable computing means.

The edge switch also comprises a NIC 120 for providing an out of band interface for connecting to external entities such as a craft for local maintenance and configuration purposes, an NMS for centralized provisioning, administration and control or a Local Area Network (LAN). The network device may comprise additional interfaces, such as a serial interface for connecting to a PC for configuration purposes.

The central processor 112 implements the major functionality of the provider edge switch including higher software layer processing. Note that the central processor may be implemented in any suitable manner such as a microcontroller, microprocessor, microcomputer, ASIC core, FPGA core, central processing unit (CPU) or digital signal processor (DSP) or any other computing means.

The client edge ports and network ports may be implemented on one or more line interface cards that provide the PHY interface to bidirectional communication links, in addition to the MAC interface. Note that the invention is not limited to any particular line interface type or link speed. In addition, the invention is not limited to any particular number of user or network ports, as any number of links of each type may be used. Further, the line interface cards may be adapted to interface to any type of communication links such as any variety of copper or optical based Ethernet, Token Ring, FDDI, SONET/SDH, PDH, ATM, RPR, etc.

The network device also comprises an optional user interface adapted to respond to user inputs and provide feedback and other status information. A host/user interface 126 enables communication with a user or host-computing device 124. The host may be adapted to configure, control and maintain the operation of the device. The device may also comprise magnetic storage device means for storing application programs and data.

The network device comprises computer readable storage medium for storing program code and data which may include any suitable memory means including but not limited to magnetic storage, optical storage, CD-ROM drive, ZIP drive, DVD drive, DAT cassette, semiconductor based volatile or non-volatile memory, biological memory devices, or any other memory storage device.

Note that a network core device may have the same structure as a provider edge device, except for example, not having a user/edge (UNI) port for connecting to client and/or access (E-domain) devices, and having a higher port density and bandwidth capacity.

Software operative to implement the functionality of the E-tree interoperability mechanism may be adapted to reside on a computer readable medium, such as a magnetic disk within a disk drive unit or any other volatile or nonvolatile memory. In this example switch, the software adapted to implement the portion of the E-tree interoperability translation mechanism that executes on the network processor is implemented within the ingress packet processing block 100 (depicted in block 101) and within the egress packet processing block 102 (depicted in block 103). For example, a table, maintained by the CPU, can be used in performing ingress and egress processing. The table comprises VPLS, MPLS and VSI related MAC address and other information including VLAN address translation information. Alternatively, the computer readable medium may comprise a floppy disk, Flash memory, EPROM, EEPROM based memory, ROM storage, etc. The software adapted to perform mechanisms or any portion thereof may also reside, in whole or in part, in the static or dynamic main memories or in firmware within the processor of the switch (i.e. within microcontroller, microprocessor, microcomputer, DSP, etc. internal memory).

In alternative embodiments, the methods of the present invention may be applicable to implementations of the invention in integrated circuits (ICs), field programmable gate arrays (FPGAs), chip sets or application specific integrated circuits (ASICs), DSP circuits, wireless implementations and other communication system products.

The terminology used herein is for the purpose of describing particular embodiments only and is not intended to be limiting of the mechanism. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the mechanism has been presented for purposes of illustration and description, but is not intended to be exhaustive or limited to the mechanism in the form disclosed. As numerous modifications and changes will readily occur to those skilled in the art, it is intended that the mechanism not be limited to the limited number of embodiments described herein. Accordingly, it will be appreciated that all suitable variations, modifications and equivalents may be resorted to, falling within the spirit and scope of the mechanism. The embodiments were chosen and described in order to best explain the principles of the mechanism and the practical application, and to enable others of ordinary skill in the art to understand the mechanism for various embodiments with various modifications as are suited to the particular use contemplated.

What is claimed is:

1. A method of E-tree interoperability between E-domain devices incorporating bridging and VPLS-domain devices, said method for use on E-domain devices neighboring a VPLS-domain device, said method comprising:
segregating root traffic to a root-to-leaf VLAN;
segregating leaf traffic to a leaf-to-root VLAN; and
performing asymmetric VLAN translation on traffic between said E-domain devices and said VPLS-domain devices.

2. The method according to claim 1, wherein said VPLS-domain devices comprise MPLS devices supporting Virtual Private LAN Switching.

3. The method according to claim 1, wherein said VPLS-domain devices comprise Provider Bridging (PB) devices supporting Virtual Private LAN Switching.

4. The method according to claim 1, wherein said VPLS-domain devices comprise Provider Backbone Bridging (PBB) devices supporting Virtual Private LAN Switching.

5. The method according to claim 1, wherein said E-domain devices comprise IEEE 802.1ad Provider Bridge (PB) devices.

6. The method according to claim 1, wherein said E-domain devices comprise IEEE 802.1Q VLAN bridging devices.

7. The method according to claim 1, wherein said E-domain devices comprise Q-in-Q bridging devices.

8. The method according to claim 1, where root endpoints are not directly connected to the said E-domain.

9. The method according to claim 1, where traffic flows between said VPLS-domain and root endpoints directly connected to said E-domain through dedicated VLAN-spoke connections.

10. The method according to claim 1, wherein said step of performing asymmetric VLAN translation comprises translating a VLAN tag in ingress traffic received from said VPLS domain to a root-to-leaf VLAN tag for forwarding to said E-domain.

11. The method according to claim 1, wherein said step of performing asymmetric VLAN translation comprises translating a leaf-to-root VLAN tag in egress traffic received from said E-domain to a VLAN tag for forwarding to said VPLS domain.

12. The method according to claim 1, wherein said step of performing asymmetric ingress VLAN translation is performed on a frame before any switching, bridging or forward decision processing is performed thereon.

13. The method according to claim 1, wherein said step of performing asymmetric egress VLAN translation is performed on a frame after any switching, bridging or forward decision processing is performed.

14. The method according to claim 1, wherein some traffic between said E-domain and said VPLS domain undergoes asymmetric VLAN translation while other traffic is left intact.

15. A method of E-tree interoperability between E-domain devices incorporating bridging and VPLS-domain devices, said method for use on E-domain devices neighboring a VPLS-domain device, said method comprising:
segregating traffic between root endpoints in said E-domain and between said root endpoints in said E-domain and the VPLS domain to a root VLAN;
segregating traffic from the VPLS domain destined to leafs in said E-domain to a root-to-leaf VLAN;
segregating traffic originated by leafs destined to roots to a leaf-to-root VLAN;
forwarding traffic between said root VLAN and root-to-leaf VLAN and leaf-to-root VLAN; and
performing asymmetric VLAN translation on traffic between said E-domain devices and said VPLS-domain devices.

16. The method according to claim 15, wherein traffic is forwarded from said leaf-to-root VLAN in said E-domain to root endpoints in said E-domain via a VSI in a VPLS domain device.

17. The method according to claim 15, wherein traffic is forwarded from said root VLAN in said E-domain to said root-to-leaf VLAN in said E-domain via a VSI in a VPLS domain device.

18. The method according to claim 15, wherein said step of performing asymmetric VLAN translation comprises translating a VLAN tag in traffic received from said VPLS domain to a root-to-leaf VLAN tag for forwarding to said E-domain.

19. The method according to claim 15, wherein said step of performing asymmetric VLAN translation comprises translating a leaf-to-root VLAN tag in traffic received from said E-domain to a VLAN tag for forwarding to said VPLS domain.

20. The method according to claim 15, wherein said step of performing asymmetric ingress VLAN translation is performed on a frame before any switching, bridging or forward decision processing is performed thereon.

21. The method according to claim 15, wherein said step of performing asymmetric egress VLAN translation is performed on a frame after any switching, bridging or forward decision processing is performed thereon.

22. The method according to claim 15, wherein some traffic between said E-domain and said VPLS domain undergoes asymmetric VLAN translation while other traffic is left intact.

23. An apparatus for E-tree interoperability between E-domain devices incorporating bridging and VPLS domain devices for use on E-domain devices neighboring a VPLS-domain device, comprising:
a communications circuit operative to transmit and receive a traffic stream between an E-domain and a VPLS domain and segregating said traffic into separate root-to-leaf and leaf-to-root VLANs in said E-domain;
a packet forwarder operative to forward traffic between said root and leaf VLANs wherein said VPLS domain receives traffic from a single VLAN in said E-domain; and
a translation module operative to perform asymmetric VLAN tag translation on traffic between said E-domain devices and said VPLS-domain devices.

24. The apparatus according to claim 23, wherein said translation module comprises means for translating a VLAN tag in ingress traffic received from said VPLS domain to a root-to-leaf VLAN tag for forwarding to said E-domain.

25. The apparatus according to claim 23, wherein said translation module comprises means for translating a leaf-to-root VLAN tag in egress traffic received from said E-domain to a VLAN tag for forwarding to said VPLS domain.

26. The apparatus according to claim 23, wherein asymmetric ingress VLAN translation is performed on a frame before any switching, bridging or forward decision processing is performed thereon.

27. The apparatus according to claim 23, wherein asymmetric egress VLAN translation is performed on a frame after any switching, bridging or forward decision processing is performed thereon.

28. The apparatus according to claim 23, wherein some traffic between said E-domain and said VPLS domain undergoes asymmetric VLAN translation while other traffic is left intact.

29. An E-domain switch for use in providing an E-tree service, said E-domain device neighboring a VPLS domain device, said E-domain switch comprising:
a plurality of network ports for interfacing said switch to one or more communication links;
a packet processor comprising an ingress packet processor and an egress packet processor;
an E-tree interoperability module operative to:
segregate traffic between root endpoints in said E-domain and between said root endpoints in said E-domain and the VPLS domain to a root VLAN;
segregate traffic from the VPLS-domain destined to leafs in said E-domain to a root-to-leaf VLAN;
segregate traffic originated by leafs destined to roots to a leaf-to-root VLAN;
forward traffic between said root VLAN and root-to-leaf and leaf-to-root VLANs; and
perform asymmetric VLAN translation on traffic between said E-domain devices and said VPLS-domain devices.

30. The switch according to claim 29, wherein traffic is forwarded from said leaf-to-root VLAN in said E-domain to root endpoints in said E-domain via a VSI in a VPLS domain device.

31. The switch according to claim 29, wherein traffic is forwarded from said root VLAN in said E-domain to said root-to-leaf VLAN in said E-domain via a VSI in a VPLS domain device.
